(19) United States
(12) Patent Application Publication
(10) Pub. No.: US 2006/0256772 A1
(43) Pub. Date: Nov. 16, 2006

(54) Selecting a network for routing real-time audio

(75) Inventor: Madhu Yarlagadda, Los Altos, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/128,646

(22) Filed: May 12, 2005

(51) Int. Cl. H04L 12/66

(52) U.S. Cl. 370/352

(57) ABSTRACT

A system, method, and apparatus are directed towards managing a Voice over IP (VOIP) message over a network. A computing device may be configured to select a network connection for which to send the message to a destination based on a variety of factors. Duplicate message packets may be communicated to the destination device through multiple network connections. The multiple network connections may include a peer-to-peer network connection, a peer network connection, an ad-hoc network connection, or the like. Metrics may be collected about the multiple network connections. A determination may be made based, in part, on the metrics whether one network connection is optimal over another network connection. If so, that network connection may be selected to continue to provide the message packets, and the communication of the duplicate packets is ceased.

### BACKGROUND OF THE INVENTION

The present invention relates generally to network communications, and more particularly, but not exclusively, to a system and method for selecting a network from disparate networks for routing an audio message, such as a real-time audio message.

Internet Protocol (IP) Telephony, also known as Voice over Internet Protocol (VOIP), is a technology that makes it possible to have a voice conversation over an IP network, such as the Internet, instead of a dedicated voice transmission line.

Depending on the service, one way to place a VOIP call is to employ specialized phones, sometimes called IP Phones, or VOIP phones, that may look like a normal phone. Such VOIP phones may connect to the network through an RJ-45 connector, or operate through a wireless connection. In a possible VOIP phone call scenario, consider where both parties employ IP telephony systems. The caller's voice packets might be sent through a media gateway to be converted to a circuit-switched voice connection using traditional public switched telephone networks (PSTNs). The PSTN may then carry the call to an appropriate destination, where the call might then go through another media gateway to be converted back to IP packets.

Because many carrier backbones may use VOIP internally, additional conversions may be added to this process. Thus, the portion of the call that traverses the PSTN may also pass through another pair of media gateways that convert the circuit-switched voice to packet voice on a carrier's IP backbone and then back again. Depending upon the path selected, the network type, the number of conversions, time of day, how congested the selected path may be, voice calls could be subject to unpredictable packet latency and jitter. Thus, there is a need in the industry to improve how VOIP messages are managed over a networking infrastructure. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of various network connections that may be employed in a system implementing the invention;

FIG. 3 shows one embodiment of a client device that may be included in a system implementing the invention; and

FIG. 4 illustrates a logical flow diagram generally showing one embodiment of a process for managing a VOIP message at a client, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards a system, method, and apparatus for managing a Voice over IP (VOIP) message over a network. A computing device may be configured to select a network connection for which to send the VOIP message to a destination based on a variety of factors. Such factors may include, for example, a characteristic of connection from a source device, a destination device, and the like. In one embodiment, duplicate VOIP message packets may be communicated to the destination device through multiple network connections. Metrics may be collected about the multiple network connections during a predefined period of time, for a predefined number of packets sent, or virtually any other criteria. Such metrics may include a number of hops, a packet latency, a time of day, a termination costs, a licensing fee arrangement, and so forth. A determination may then be made whether one network connection provides an advantage with respect to the collected metrics over another network connection. If so, that network connection may be selected to continue to provide the message, and the communication of the duplicate packets is ceased. In one embodiment, the multiple network connections include a peer-to-peer network connection, a peer network connection, and an ad-hoc network connection.

It should be clear, that while the present invention describes selecting network connections for VOIP messages, the invention is not so limited. That is, selecting network connections as described by the present invention may be performed for virtually any type of network message, including FTP messages, audio messages, video messages, email messages, IM messages, HTTP messages, and so forth.

Illustrative Operating Environment

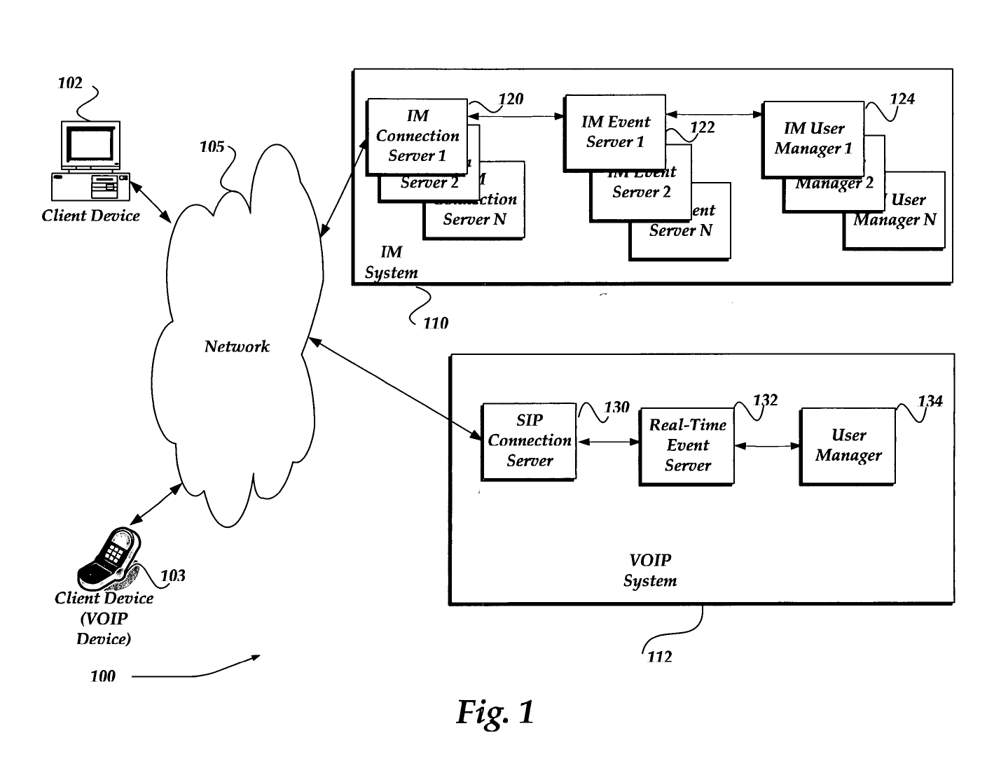

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client device 102, client device (VOIP device) 103, network 105, IM system 110, and VOIP system 112. IM system 110 may include IM connection servers 120, IM event servers 122, and IM user managers 124. VOIP system 112 includes SIP connection server 130, Real-Time event server 132, and user manager 134.

Client device 102 is in communication with IM connection servers 120 through network 105. Client device 102 is also in communication with VOIP device 103 through network 105. IM event servers 122 are in communication with IM connection servers 120 and IM user managers 124. Real-time event server 132 is in communication with SIP connection server 130 and user manager 134.

Client device 102 may include virtually any device, including personal computers, multiprocessor systems, microprocessor-based or programmable consumer electronics, network PCs, or the like, that may be capable of employing one or more network connections, including dial-up, Digital Subscriber Lines (DSLs), WIreless-FIdelity (Wi-Fi), local area networks (LANs), wide area networks (WANs), World Interoperability for Microwave Access (Wi-Max), or the like.

VOIP device 103 is another embodiment of a client device. VOIP device 103 may include virtually any device that is arranged to send and receive voice communications and messages such as VOIP message via one or more wired and/or wireless communication interfaces. Typically, VOIP device 103 may be configured to communicate using any of a variety of protocols. For example, VOIP device 103 may be configured to employ Real-time Transport Protocol (RTP) for communicating media data such as audio and video to another device. However, the invention is not so limited, and another media data mechanism may be employed, including IAX, and the like. VOIP device 103 may also employ the Session Initiation Protocol (SIP) protocol for enabling setting up a session and enabling such actions as dialing a number, enabling a ring, a ring-back tone, busy signal, and the like. However, other signaling protocols may also be employed, including H.323, Skinny Client Control Protocol (SCCP), IAX, MiNET, and the like. Typically, however, VOIP device 103 may employ SIP over either UDP or TCP and RTP over UDP.

VOIP device 103 may also be configured to provide an identifier, sometimes known as an originating line identifier (OLI) during a communication. The identifier may employ any of a variety of mechanisms, including a device model number, a carrier identifier, a mobile identification number (MIN), and the like. The MIN may be a telephone number, a Mobile Subscriber Integrated Services Digital Network (MS-ISDN), an electronic serial number (ESN), or other device identifier. The OLI may also be an IP address associated with VOIP device 103. In one embodiment, VOIP device 103 may also employ an Electronic NUMbering (ENUM) mechanism to obtain the IP address from a phone number. In one embodiment, the identifier is provided with each communication. In another embodiment, the identifier is provided by an end-user.

Devices that may operate as VOIP device 103 include personal computers, desktop computers, smart phones, Personal Digital Assistants (PDAs), handheld computers, programmable consumer electronics, standard telephones configured with an analog telephone adaptor (ATA), an IP phone, a mobile device, and the like.

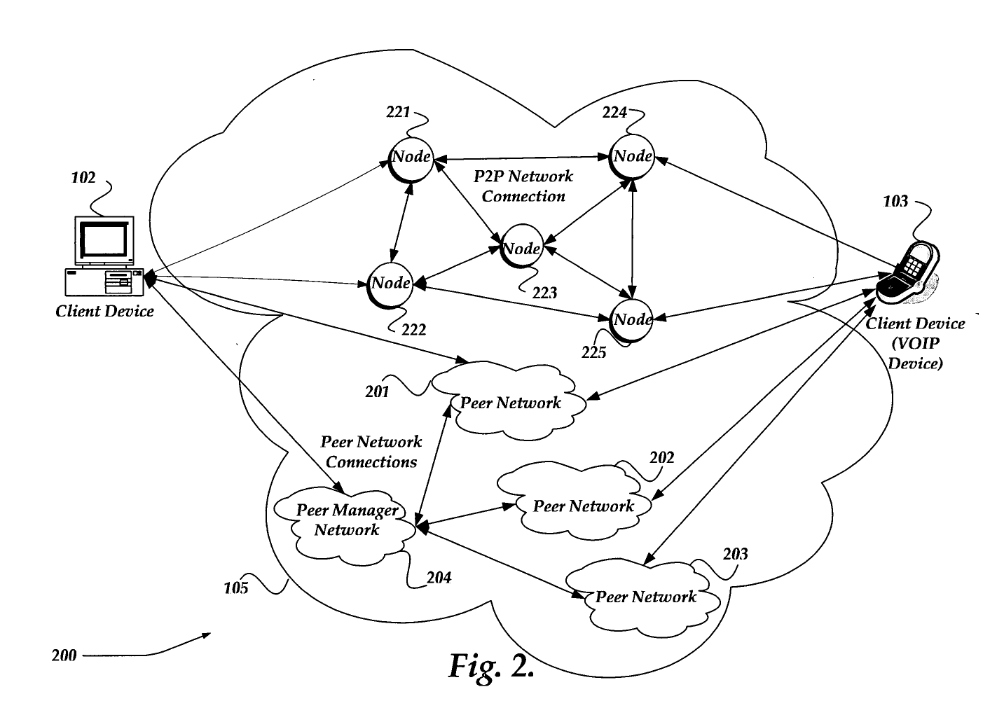

One embodiment of client device 102 is described in more detail below in conjunction with FIG. 2. Briefly, however, client device 102 may include virtually any computing device capable of receiving and sending a message over a network, to and from another computing device, each other, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client device 102 may be any device that is capable of connecting using a wired or wireless communication medium such as a PDA, POCKET PC, wearable computer, and any other device that is equipped to communicate over a wired and/or wireless communication medium.

Client device 102 may be further configured to communicate with VOIP device 103 using a VOIP protocol. Thus, client device 102 represents another embodiment of a VOIP capable device. Client device 102 may employ a connection agent (not shown) that is configured select a network connection for which to communicate a VOIP message with another device, such as VOIP device 103. As described below, connection agent may be configured to initially select multiple network connections for which to send duplicates VOIP packets to the other device. VOIP may gather metrics regarding the multiple network connections, and based, in part, on the metrics select a single network connection for which to continue the VOIP communications with the other device. In one embodiment, client device 102 may further provide the gathered metrics to a server device for storage, and for possible use by another computing device. In one embodiment, the server device is SIP connection server 130. However, the invention is not so limited, and virtually any server may be employed, including one not illustrated in FIG. 1.

Network 105 is further described below, in conjunction with FIG. 2. Briefly, however, network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 may include any communication method by which information may travel between computing devices.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

IM system 110 is configured to manage IM sessions between client devices employing an IM client. IM system 110 may employ IM connection servers 120, IM event servers 122, and IM user managers 124 to manage one or more IM sessions. In one embodiment, IM connection servers 120, IM event servers 122, and IM user managers 124 may represent separate server processes operating with a single computing device. In another embodiment, IM connection servers 120, IM event servers 122, and IM user managers 124 may represent distinct processes operating across multiple computing devices. As such, IM system 110 may be implemented on a variety of computing devices including personal computers, desktop computers, multiprocessor systems, microprocessor-based devices, network PCs, servers, network appliances, and the like.

IM connection servers 120 are configured to receive a request to establish an IM session from an IM client, such as might be included within client device 102, and the like. IM connection servers 120 may also receive from the IM client authentication information that may be employed to authenticate an end-user of the IM client. If the end-user is authenticated, IM connection servers 120 may enable the IM client to log into the IM session. IM connections servers 120 may also be configured to provide information about the established session to IM event servers 122.

IM connections servers 120 may also forward various request information from the IM client to IM event servers 122. Such request information may include, for example, a request to locate and communicate with another IM end-user.

IM event servers 122 are configured to receive the end-user's log in and other request information from IM connections servers 120. IM event servers 122 may request IM user managers 124 to store information about the IM client and end-user. IM user mangers 124 may employ a table, spreadsheet, file, database, and the like, to register the IM client, and on which IM connection server, within IM connection servers 120, the IM client is logged into. Thus, IM user managers 124 may store information about various IM conversations that may include such information as identifiers for end-users associated with an IM conversation, time information, account identifiers for the end-users, IM connection servers associated with an IM conversation, and so forth. As such, IM event servers 122 may also employ IM user managers 124 to determine which IM connection server, within IM connection servers 122, another end-user is logged into, and provide such information to IM connection servers 120, so that an IM session may be established between two or more IM end-users.

VOIP system 112 is configured to manage VOIP sessions between client devices using any of a variety of IP telephony protocols. VOIP system 112 is further configured to enable a variety of client devices and client applications to access voice mail messages.

As shown, VOIP system 112 may be implemented in a single computing device, with each of the illustrated components operating as one or more processes with the single computing device. VOIP system 112 may also be implemented across multiple computing devices, with one or more of the illustrated components distributed across the multiple computing devices. As such VOIP system 112 may be implemented on a variety of computing devices including personal computers, desktop computers, multiprocessor systems, microprocessor-based devices, network PCs, servers, network appliances, and the like.

SIP connection server 130 is configured to receive a request to establish a SIP connection from client device 102, VOIP device 103, and the like. The requesting device may provide identification information to SIP connection server 130 that may be used, at least in part, to authenticate the request to establish the SIP connection. If the requesting device is authenticated, SIP connection server 130 may enable the requesting device to log into a connection. SIP connection server 130 may also provide information about the requesting device to real-time event server 132. Real-time event server 132 may be configured to receive the information and provide it to user manager 134 for storage.

User manager 134 may store the information in a database, spreadsheet, table, file, and the like. Such information may include, for example, an identifier associated with the requesting device, an end-user associated with the requesting device, an address associated with SIP connection server 130, and the like. User manager 134 may receive and manage such information for a plurality of requesting device. User manager 134 may also provide information to real-time event server 132 about at least one other requesting device, such that SIP connection server 130 may enable a VOIP communication between one or more end-users.

Illustrative Network Connections

FIG. 2 shows one embodiment of a network structure (200) that may be included in a system implementing the invention. Network structure 200 may include many more or less components than those shown in FIG. 2. However, the components shown are sufficient to disclose an illustrative embodiment for practicing the present invention. Briefly, the invention enables, a client device, such as client device 102 to select a network connection for which to communicate with another computing device, such as client device 103.

As shown in the figure, network structure 200 includes network 105, and client devices 102-103. Network 105 includes two examples of possible network connections, a peer-to-peer (P2P) network connection, and a peer network connection. However, network 105 is not constrained to these two network connection structures, and virtually any network connection structure may be employed within network 105 for use in communicating a message between client devices 102 and 103. For example, network 105 may include an ad-hoc network connection structure, a hierarchical network connection structure, a client/server network connection structure, and so forth.

The P2P network connection includes nodes 221-225. Node 221 is in communication with nodes 222-224. Node 223 is also in communication with nodes 221, 222, 224, and 225. Node 225 also is in communication with 222 and 224. Nodes 221-222 are also in communication with client device 102, while nodes 224-225 are in communication with client device 103.

Briefly, the P2P network connection represents one embodiment of a network connection structure, wherein each of the nodes 221-225 may be configured to operate with substantially equivalent capabilities, including substantially equivalent networking responsibilities. Thus, nodes 221-225 may be implemented on any of a variety of computing devices including personal computers, desktop computers, multiprocessor systems, microprocessor-based devices, network PCs, servers, network appliances, and the like. Moreover, in one embodiment, nodes 221-225 may also represent an Internet Server Provider (ISP)'s networking infrastructure, or similar network service provider. In that embodiment, the node(s) representing an ISP may include any of a variety of networking components (not shown).

The peer network connection includes peer manager network 204, and peer networks 201-203. Peer manager network 204 is in communication with networks 201-203. Peer manager network 204 is in communication with client device 102, while peer networks 201-203 are in communication with client device 103. Client device 102 is further in communication with peer network 201. Although not illustrated, it is clear that client device 102 may also be in communication with peer network 202, and/or peer network 203.

Briefly, a peer network connection represents networking arrangements between peer manager network 204, and each of peer networks 201-203. For example, peer network 201 may have arranged a licensing agreement with peer manager network 204 to provide a dedicated network connection, or similar communication infrastructure, between peer manager network 204 and itself. Similarly, peer networks 202-203 may also have agreements with peer manager network 204 to provide a network connection. In one embodiment, the network connections may include a virtual private network (VPN), an encrypted tunnel, privately leased lines, a dedicated high speed connection using any of a variety of communications, a Frame-Relay connection, an ATM connection, T-1, T-2, T-3 connections, and so forth. Furthermore, one or more of peer networks 201-203 may have an agreement to provide a particular service to client device 103. Thus, in one embodiment, one or more of peer manager network 204 and/or peer networks 201-203 may represent an Internet Server Provider (ISP)'s networking infrastructure, a dedicated phone company's networking infrastructure, or similar network service provider's networking infrastructure. Furthermore, one example of peer manager network 204 might be the Yahoo!, Inc. networking infrastructure.

In addition, each of peer manager network 204 and peer networks 201-203 may include many of the components as described above for network 105. Thus, each of peer manager network 204 and peer networks 201-203 may be enabled to employ any form of computer readable media for communicating information from one electronic device to another.

In addition, peer manager network 204 may include one or more components (not shown) that are configured to receive network metrics from one computing device, such as client device 102 for use by the computing device, and/or by another computing device. Thus, the one or more components may include personal computers, desktop computers, multiprocessor systems, microprocessor-based devices, network PCs, servers, network appliances, and the like.

Illustrative Client Device

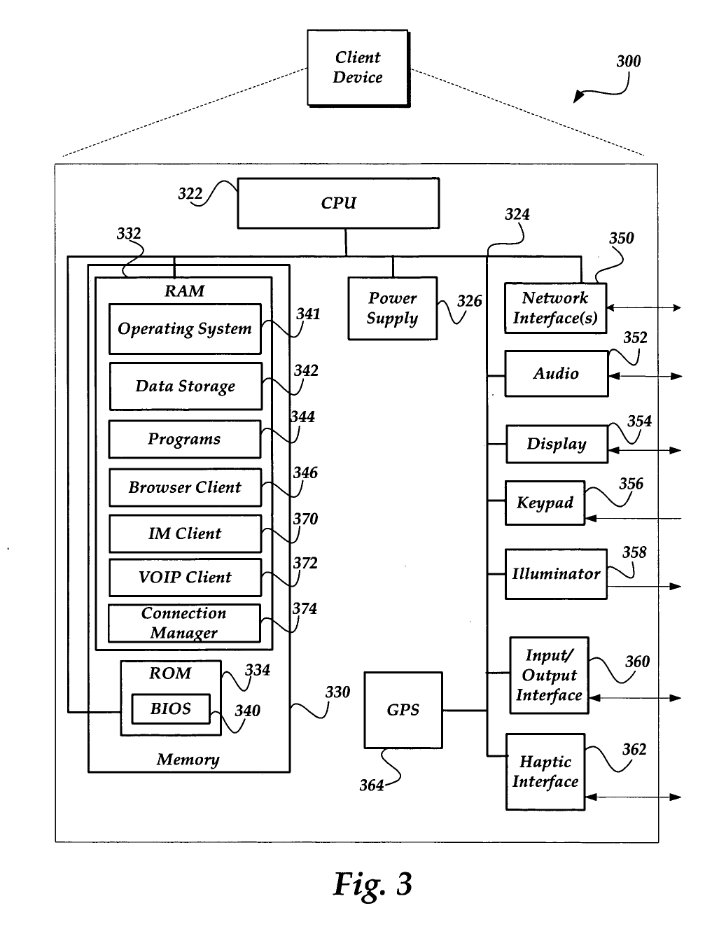

FIG. 3 shows one embodiment of client device 300 that may be included in a system implementing the invention. Client device 300 may include many more or less components than those shown in FIG. 3. However, the components shown are sufficient to disclose an illustrative embodiment for practicing the present invention. In one embodiment, client device 300 may represent client device 102 and/or client device 103 of FIGS. 1-2.

As shown in the figure, client device 300 includes a processing unit 322 in communication with a mass memory 330 via a bus 324. Client device 300 also includes a power supply 326, one or more network interfaces 350, an audio interface 352, a display 354, a keypad 356, an illuminator 358, an input/output interface 360, a haptic interface 362, and an optional global positioning systems (GPS) receiver 364. Power supply 326 provides power to client device 300. A rechargeable or non-rechargeable battery may be used to provide power. The power may also be provided by an external power source, such as an AC adapter or a powered docking cradle that supplements and/or recharges a battery.

Client device 300 may optionally communicate with a base station (not shown), or directly with another computing device. Network interface 350 includes circuitry for coupling client device 300 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, and the like.

Audio interface 352 is arranged to produce and receive audio signals such as the sound of a human voice. For example, audio interface 352 may be coupled to a speaker and microphone (not shown) to enable telecommunication with others and/or generate an audio acknowledgement for some action. Display 354 may be a liquid crystal display (LCD), gas plasma, light emitting diode (LED), or any other type of display used with a computing device. Display 354 may also include a touch sensitive screen arranged to receive input from an object such as a stylus or a digit from a human hand.

Keypad 356 may comprise any input device arranged to receive input from a user. For example, keypad 356 may include a push button numeric dial, or a keyboard. Keypad 356 may also include command buttons that are associated with selecting and sending images. Illuminator 358 may provide a status indication and/or provide light. Illuminator 358 may remain active for specific periods of time or in response to events. For example, when illuminator 358 is active, it may backlight the buttons on keypad 356 and stay on while the client device is powered. Also, illuminator 358 may backlight these buttons in various patterns when particular actions are performed, such as dialing another client device. Illuminator 358 may also cause light sources positioned within a transparent or translucent case of the client device to illuminate in response to actions.

Client device 300 also comprises input/output interface 360 for communicating with external devices, such as a headset, or other input or output devices not shown in FIG. 3. Input/output interface 360 can utilize one or more communication technologies, such as USB, infrared, Bluetooth™, and the like. Haptic interface 362 is arranged to provide tactile feedback to a user of the client device. For example, the haptic interface may be employed to vibrate client device 300 in a particular way when another user of a computing device is calling.

Optional GPS transceiver 364 can determine the physical coordinates of client device 300 on the surface of the Earth, which typically outputs a location as latitude and longitude values. GPS transceiver 364 can also employ other geo-positioning mechanisms, including, but not limited to, triangulation, assisted GPS (AGPS), E-OTD, CI, SAI, ETA, BSS and the like, to further determine the physical location of client device 300 on the surface of the Earth. It is understood that under different conditions, GPS transceiver 364 can determine a physical location within millimeters for client device 300; and in other cases, the determined physical location may be less precise, such as within a meter or significantly greater distances.

Mass memory 330 includes a RAM 332, a ROM 334, and other storage means. Mass memory 330 illustrates another example of computer storage media for storage of information such as computer readable instructions, data structures, program modules or other data. Mass memory 330 stores a basic input/output system (“BIOS”) 340 for controlling low-level operation of client device 300. The mass memory also stores an operating system 341 for controlling the operation of client device 300. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 330 further includes one or more data storage 342, which can be utilized by client device 300 to store, among other things, programs 344 and/or other data. For example, data storage 342 may also be employed to store information that describes various capabilities of client device 300. The information may then be provided to another device based on any of a variety of events, including being sent as part of a header during a communication, sent upon request, and the like.

Programs 344 may include computer executable instructions which, when executed by client device 300, transmit, receive, and/or otherwise process messages (e.g., SMS, MMS, IM, email, and/or other messages), audio, video, and enable telecommunication with another user of another client device. Other examples of application programs include calendars, contact managers, task managers, transcoders, database programs, word processing programs, spreadsheet programs, games, and so forth. In addition, mass memory 330 stores browser client 346, IM client 370, VOIP client 372, and connection manager 374.

Browser 346 may be configured to receive and to send web pages, web-based messages, and the like. Browser 346 may, for example, receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

IM client 370 may be configured to initiate and manage an instant messaging session, including, but not limited to AOL Instant Messenger, Yahoo! Messenger, .NET Messenger Server, ICQ, and the like. In one embodiment, IM client 370 is configured to receive VOIP messages from a VOIP client, such as VOIP client 372, and integrate IM/VOIP features. In one embodiment, IM client 370 may employ SIP to establish media sessions with another computing device employing an IM/VOIP capable client, and RTP to communicate the media traffic. However IM client 370 is not so limited. For example, IM client 370 may also employ any of the following SIMPLE (SIP for Instant Messaging and Presence Leverage), APEX (Application Exchange), Prim (Presence and Instant Messaging Protocol), the open XML-based XMPP (Extensible Messaging and Presence Protocol), more commonly known as Jabber and OMA (Open Mobile Alliance)'s IMPS (Instant Messaging and Presence Service) created specifically for mobile devices, and the like.

VOIP client 372 is configured to enable client device 300 to initiate and manage a VOIP session with another client device. VOIP client 372 may employ the SIP protocol for managing signaling, and RTP for transmitting the VOIP traffic (“media”). However, the invention is not so constrained, and any of a variety of other VOIP protocols may be employed including IAX which carries both signaling and voice data, H.323, SCCP, Megaco, MGCP, MiNET, Skinny Client Control Protocol (SCCP), and the like. VOIP client 372 is further configured to employ a variety of speech codecs to compress the media stream for communicating it over the network, including G.711, G.729, G.729a, iSAC, Speex, and the like. In one embodiment, SIP may be employed to enable a Session Description Protocol (SDP).

Although not shown, client device 300 may also be configured to receive a message from another computing device, employing another mechanism, including, but not limited to email, Short Message Service (SMS), Multimedia Message Service (MMS), internet relay chat (IRC), mIRC, and the like.

Connection agent 374 may be configured to manage communication connections to a destination device. Connection agent 374 may do so, in part, by receiving a message from browser client 346, IM client 370, VOIP client 372, or another program (344), such as an email message and the like. Connection agent 374 may then determine whether to send duplicate packets of the message towards the destination device. If connection agent 374 determines to send duplicate packets of the message to the destination device, connection agent 374 may do so by employing multiple network connections. For example, connection agent 374 may send one packet to the destination device using a P2P network connection, and a duplicate of the packet using a peer network connection. As connection agent 374 continues sending duplicate packets it may be configured to also collect a variety of metrics associated with the multiple network connections. Although virtually any metric may be collected, in one embodiment, connection agent 374 may collect metrics such as a number of hops, a latency, a packet loss, a termination cost, other costs, and the like. After a predefined period of time, a predefined number of packets being sent, or virtually any other criteria, connection agent 374 may then select a single network connection to continue the communications between client device 300 and the destination device, based, at least in part, on the collected metrics.

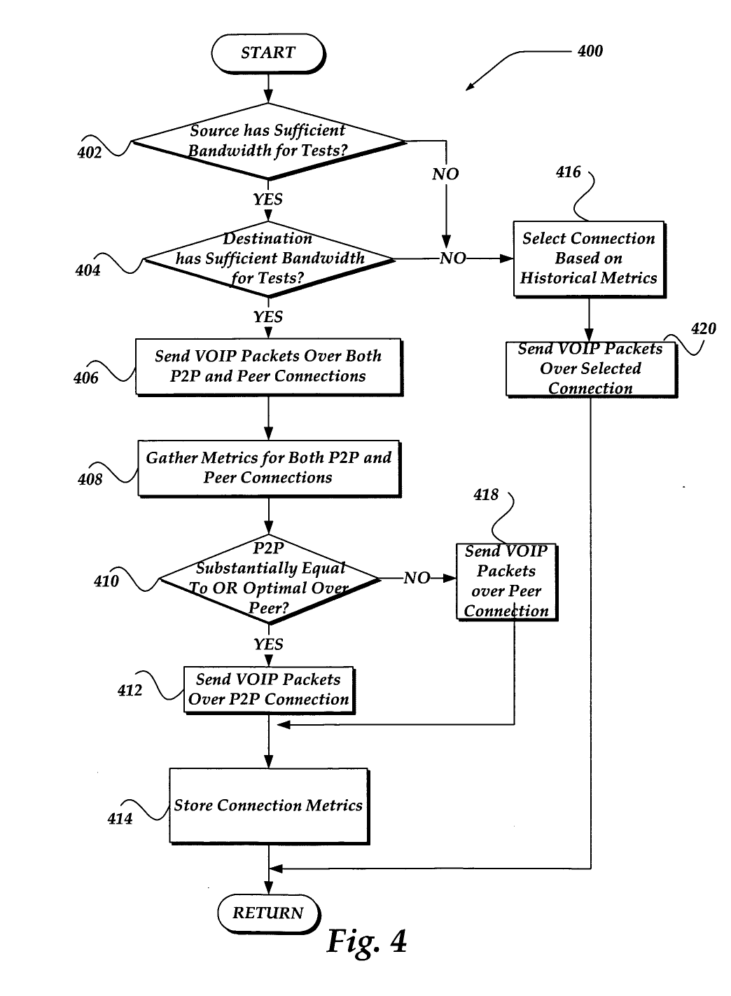

Connection agent 374 may also be configured to determine not to send duplicate packets based on a variety of reasons, including a bandwidth at client device 300, a bandwidth at the destination device, or the like. If connection agent 374 determines not to send duplicate packets, connection agent 374 may select a network connection based on historical metrics about various network connections between itself and the destination device. In one embodiment, connection agent 374 may receive the historical metrics from another computing device, such as a remote server. However, the invention is not so limited, and connection agent 374 may have collected and stored such historical metrics based on a previous communication. Connection agent 374 may also be configured to employ a process such as process 400 of FIG. 4 to perform at least some of its actions.

Generalized Operation

The operation of certain aspects of the invention will now be described with respect to FIG. 4. FIG. 4 illustrates a logical flow diagram generally showing one embodiment of a process for managing a VOIP message at a client, in accordance with the present invention. Process 400 of FIG. 4 may, for example, be implemented within one or more of client devices 102-103 of FIG. 1. Moreover, although process 400 is described in terms of VOIP message packets the invention is not so limited; and, virtually any message packet type may be employed. Thus, for example, process 400 may also be employed to select a network connection for an audio message, a video message, an IM message, and the like. Moreover, process 400 has been simplified to show an evaluation between two network connections, a peer network connection, and a P2P network connection. However, the invention is not so constrained, and any number of network connections may be used by expanding process 400.

Process 400 begins, after a start block, at decision block 402, where a source device intends to send a message to a destination device. At this point, source device may have initially established a VOIP connection with the destination device using SIP, H.323, or the like. Thus, at decision block 402, a determination is made whether the source device's network connection to a network, such as network 105 of FIG. 105 includes sufficient bandwidth to perform a network connection test. Such network connection may, for example, be from the source device to its Internet Service Provider (ISP). Moreover, it should be understood, that the source device, may have available to it, multiple local network connections. For example, the source device may be configured to use a wireless connection, a broadband connection, a narrowband connection, and the like. Therefore, in one embodiment, each of these local network connections may be examined to determine their respective bandwidth capabilities. Sufficient bandwidth may be based on any of a variety of criteria, including, but not limited, to a quality of service, packet loss, magnitude of bandwidth for the number of multiple network connections and packets to be sent, or the like. In any event, if it is determined that there is insufficient bandwidth, processing flows to block 416; otherwise, processing flows to decision block 404.

At decision block 404, a determination is made whether the destination device's connection to the network includes sufficient bandwidth to perform the connection test. Such information about the destination's network bandwidth may be obtained using any of a variety of mechanisms, including sending the destination device, or an intermediate device, a request for such information. In any event, if it is determined that the destination device's connection to the network is insufficient to perform the connection test, processing branches to block 416; otherwise, processing flows to block 406.

At block 406, the source device selects multiple network connections for which duplicate VOIP packets will be sent across to the destination device. In one embodiment, and as illustrated, the multiple network connections include a P2P and a peer network connection. However, the invention is not limited to comparing just these two network connection types, and others (and/or more) may be employed by the invention. In any event, upon selection of the multiple network connections, the source device sends duplicate VOIP packets over the other multiple network connections. This may be possible, because the destination device may be configured to drop or otherwise ignore duplicate VOIP packets.

Process 400 continues to block 408, where metrics are collected. The metrics may be collected over a predefined period of time for which the duplicate packets are sent over the multiple network connections, after sending of a predefined number of packets, or based on virtually any other criteria. Such metrics may include, but are not limited to, a number of hops, a latency, a packet loss, a cost, a quality of service, a licensing arrangement, and the like. Processing next flows to decision block 410, where a comparison is made of the collected metrics for the multiple network connections to determine if one of the multiple network connections is optimal over the others. Such comparisons may include a comparison of weighted metrics, at a metric by metric comparison, or the like. In any event, if it is determined that one of the multiple network connections is optimal over the others based, at least in part, on the collected metrics, that network connection is selected to continue communications between the two devices. Thus, as illustrated, if the metrics associated with the P2P network connection are substantially equal to or optimal over the peer network connection, the P2P network connection is selected and processing flows to block 412; otherwise, processing flows to block 418. It is noted that the test for substantial equality may be provided to address an event where there may be no clear optimal network connection. In that case, a default network connection may be selected. In the present example, as we are merely illustrating a comparison between the P2P and peer network connections, the default network connection is the P2P network connection. However, the invention is clearly not so limited, and either of the two or even another network connection may be selected as the default network connection.

At block 412, the other multiple network connections with the destination device are no longer employed to send duplicate packets, and the communication between the two devices is continued using the P2P network connection. Processing then continues to block 414.

Similarly, at block 418, the other multiple network connections with the destination device are no longer employed to send duplicate packets, and the communication between the two devices is continued using the peer network connection. Processing then continues to block 414.

At block 414, the collected metrics for the multiple network connections may be stored for use in selecting another network connection. In one embodiment, the source device may store the metrics. In another embodiment, the source device may provide the metrics to another device for storage, including the destination device, a remote server, and the like. Upon completion of block 414, process 400 then returns to a calling process to perform other actions.

Back at block 416, if it is determined that either the source device or the destination device has insufficient bandwidth to perform the network connection test historical metrics may be employed to select a network connection. The historical metrics may have been obtained from previous communications by the source device. However, the invention is not so limited. For example, the historical metrics may represent metrics from multiple computing devices. Thus, in one embodiment, the historical metrics may be received from a remote device. In another embodiment, the source device may store its own historical metrics. In any event, processing flows to block 420, where the source device may employ the selected network connection to provide the VOIP packets to the destination device. Upon completion of block 420, process 400 then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for use in managing a message over a network, comprising:
duplicating each packet in a plurality of packets;
sending the duplicate packets to a destination device over multiple network connections;
gathering metrics associated with each of the multiple network connections; and
if the metrics indicate one network connection within the multiple network connections is optimal, selecting the optimal network connection to send another plurality of packets, and discontinuing the sending of the duplicate packets over the multiple network connections.

2. The method of claim 1, wherein the message is a Voice over Internet Protocol (VOIP) message.

3. The method of claim 1, wherein the message is at least one of an audio message, or a video message.

4. The method of claim 1, further comprising:
if the metrics indicate an absence of one network connection as being optimal within the multiple network connections, selecting a default network connection to send the other plurality of packets, and discontinue the sending of duplicate packets over the multiple network connections.

5. The method of claim 4, wherein the multiple network connections include a peer network connection and a peer-to-peer network connection, and the default network connection is the peer-to-peer network connection.

6. The method of claim 1, further comprising:
if a network connection between the source device and its associated Internet Service Provider (ISP) or a network connection between the destination device and its respective ISP is determined to be of an insufficient bandwidth to manage duplicate packet flows, selecting a network connection from the multiple network connections based on historical metrics, and employing the selected network connection to send the plurality of packets to the destination device.

7. The method of claim 1, wherein the multiple network connections further comprise at least one of a peer network connection and a peer-to-peer network connection.

8. The method of claim 1, further comprising: storing the metrics.

9. The method of claim 1, wherein the method is implemented within a mobile device.

10. The method of claim 1, wherein the method is implemented as computer-readable instructions within an IM client application.

11. A method for use in managing a Voice over IP (VOIP) message over a network, comprising:
sending duplicate VOIP packets to a destination device over multiple network connections for a predetermined time;
gathering metrics associated with each of the multiple network connections for the predetermined time; and
if the metrics indicate one network connection within the multiple network connections is optimal, selecting the optimal network connection to send additional VOIP packets, and discontinue sending of duplicate VOIP packets over the multiple network connections.

12. The method of claim 11, wherein the multiple network connections further comprise at least a peer network connection and a peer-to-peer network connection.

13. A client device for use in managing a Voice over IP (VOIP) message over a network, comprising:
a transceiver for receiving and sending information to another computing device;
a processor in communication with the transceiver; and
a memory in communication with the processor and for use in storing data and machine instructions that causes the processor to perform a plurality of operations, including:
duplicating each VOIP packet in a plurality of VOIP packets;
providing the duplicate VOIP packets to a destination device over multiple network connections;
gathering metrics associated with each of the multiple network connections; and
if the metrics indicate one network connection within the multiple network connections is optimal, selecting the optimal network connection to send another plurality of VOIP packets, and discontinuing the sending of duplicate VOIP packets over multiple network connections.

14. The client device of claim 13, wherein the VOIP message further comprises at least one of a Session Initiation Protocol (SIP) packet, a Real-time Transport Protocol (RTP) packet, or a Real-time Transport Control Protocol (RTCP) packet.

15. The client device of claim 13, wherein the processor performs a plurality of operations, further comprising:
if the metrics indicate an absence of one network connection as being optimal, selecting a default network connection to send the other plurality of VOIP packets, and discontinuing the sending of duplicate VOIP packets over multiple network connections.

16. The client device of claim 13, wherein the processor performs a plurality of operations, further comprising:
if a network connection between the source device and its associated Internet Service Provider (ISP) or a network connection between the destination device and its respective ISP is determined to be of an insufficient bandwidth to manage duplicate VOIP packet flows, selecting a network connection from the multiple network connections based on historical metrics, and sending the plurality of VOIP packets to the destination device over the selected network connection.

17. The client device of claim 13, wherein the multiple network connections further comprise at least one of a peer network connection, and a peer-to-peer network connection.

18. The client device of claim 13, wherein the client device is a mobile device.

19. The client device of claim 13, wherein the metrics are stored as historical metrics on at least one of a server, or the client device.

20. A modulated data signal for use in managing a Voice over IP (VOIP) message over a network, the modulated data signal comprising instructions that enable a computing device to perform the actions of:
providing, from a source device, duplicate VOIP packets to a destination device over multiple network connections;
gathering, at the source device, metrics associated with each of the multiple network connections; and
if the metrics indicate one network connection within the multiple network connections is optimal, sending, from the source device, additional VOIP packets over the optimal network connection, and discontinuing the sending of duplicate VOIP packets over multiple network connections.

21. The modulated data signal of claim 20, further comprising:
if the metrics indicate an absence of one network connection as being optimal over the other multiple network connections, sending, from the source device towards the destination device, the other plurality of VOIP packets, and discontinue sending of duplicate VOIP packets over multiple network connections.

22. The modulated data signal of claim 20, further comprising:
if a network connection between the source device and its associated Internet Service Provider (ISP) or a network connection between the destination device and its respective ISP is determined to be of an insufficient bandwidth to manage duplicate VOIP packet flows, selecting, at the source device, a network connection from the multiple network connections based on historical metrics, and sending the plurality of VOIP packets to the destination device over the selected network connection.

23. The modulated data signal of claim 20, wherein the multiple network connections further comprise at least one of a peer network connection, and a peer-to-peer network connection.

24. The modulated data signal of claim 20, further comprising: storing the metrics for use as historical metrics.

25. The modulated data signal of claim 20, wherein at least one of the source device or the destination device is a mobile device.

26. An apparatus for managing a Voice over IP (VOIP) message over a network, comprising:
a transceiver for receiving and sending information to a computing device over the network;
means for providing duplicate VOIP packets to a destination device over multiple network connections;
means for gathering metrics associated with each of the multiple network connections; and
if the metrics indicate one network connection within the multiple network connections is optimal, employing a means for sending additional VOIP packets over the optimal network connection, and discontinuing the sending of duplicate VOIP packets over the multiple network connections.
